(19) United States
(12) Patent Application Publication
(10) Pub. No.: US 2024/0289068 A1
(43) Pub. Date: Aug. 29, 2024

(54) IMAGE PROCESSING CONTROL SYSTEM, CONTROL APPARATUS, AND IMAGE PROCESSING APPARATUS

(71) Applicant: SEIKO EPSON CORPORATION, Tokyo (JP)

(72) Inventor: Shusuke KIBUNE, MATSUMOTO-SHI (JP)

(21) Appl. No.: 18/586,862

(22) Filed: Feb. 26, 2024

(30) Foreign Application Priority Data
Feb. 27, 2023 (JP) 2023-028139
Mar. 24, 2023 (JP) 2023-047560

(51) Int. Cl. G06F 3/12

(52) U.S. Cl. CPC G06F 3/122; G06F 3/1207; G06F 3/1208; G06F 3/1256

(57) ABSTRACT

An image processing control system includes a plurality of image processing units that execute image processing for performing printing in a printing apparatus and a control unit that causes the plurality of image processing units to execute the image processing. The control unit outputs a preview data generation request of image data to be processed to the image processing unit selected from the plurality of image processing units. The selected image processing unit executes the image processing for generating preview data on the image data to generate the preview data, and outputs the generated preview data to the control unit. The control unit causes a display unit to display a print preview based on the preview data.

The present application is based on, and claims priority from JP Application Serial Number 2023-047560, filed Mar. 24, 2023, and JP Application Serial Number 2023-028139, filed Feb. 27, 2023, the disclosure of which is hereby incorporated by reference herein in its entirety.

### BACKGROUND

### 1. Technical Field

The present disclosure relates to an image processing control system, a control apparatus, and an image processing apparatus.

### 2. Related Art

In the related art, a technique has been known that speeds up image processing for performing printing. For example, JP-A-2007-310450 discloses a technique in which a print manager allocates a job to a plurality of raster image processing units (RIP) according to job contents to perform parallel processing.

JP-A-2007-310450 is an example of the related art.

Even in a distributed RIP system in which RIP processing of a job is distributed to a plurality of apparatuses, a print preview function for confirming a print result in advance is required in order to prevent a failure of printing.

### SUMMARY

In order to solve the above problems, an image processing control system is provided including a plurality of image processing units configured to execute image processing for performing printing in a printing apparatus and a control unit configured to cause the plurality of image processing units to execute the image processing. The control unit outputs a preview data generation request of image data to be processed to the image processing unit selected from the plurality of image processing units. The selected image processing unit executes the image processing for generating preview data on the image data to generate the preview data, and outputs the generated preview data to the control unit. The control unit causes a display unit to display a print preview based on the preview data.

In order to solve the above problems, a control apparatus is provided including: a control unit configured to output a preview data generation request of image data to be processed to an image processing apparatus, the image processing apparatus including an image processing unit selected from a plurality of image processing units, and cause a display unit to display a print preview based on preview data generated by the image processing unit executing image processing on the image data.

In order to solve the above problems, an image processing apparatus is provided including: an image processing unit configured to perform image processing on image data transmitted from a control apparatus to generate preview data and output the preview data to the control apparatus.

In order to solve the above problems, a non-transitory computer-readable storage medium storing a control program is provided, the control program causing a computer to function as a control unit configured to output a preview data generation request of image data to be processed to an image processing apparatus, the image processing apparatus including an image processing unit selected from a plurality of image processing units, and cause a display unit to display a print preview based on preview data generated by the image processing unit executing image processing on the image data.

In order to solve the above problems, a non-transitory computer-readable storage medium storing an image processing program is provided, the image processing program causing a computer to function as an image processing unit configured to perform image processing on image data transmitted from a control apparatus to generate preview data and output the preview data to the control apparatus.

### BRIEF DESCRIPTION OF THE DRAWINGS

FIG. 1 is a block diagram illustrating an image processing control system.

FIG. 2 is a block diagram illustrating a printing apparatus.

FIG. 3 is a block diagram illustrating a control apparatus.

FIG. 4 is a block diagram illustrating an image processing apparatus.

FIG. 5 is a table showing control information.

FIG. 6 is a table showing control information.

FIG. 7 is a flowchart of image processing.

FIG. 8 is a flowchart of communication control processing.

FIG. 9 is a diagram illustrating an operation example.

### DESCRIPTION OF EMBODIMENTS

Here, an embodiment of the present disclosure will be described according to the following order.

(1) Configuration of Image Processing Control System

(1-1) Configuration of Printing Apparatus

(1-2) Configuration of Control Apparatus

(1-3) Configuration of Image Processing Apparatus

(2) Control Information

(3) Image Processing

(4) Communication Control Processing

(5) Examples

(6) Other Embodiments

### (1) Configuration of Image Processing Control System

FIG. 1 is a diagram illustrating an example of an image processing control system 1 according to an embodiment of the present disclosure. The image processing control system 1 includes a control apparatus 10, an image processing apparatus 20, and a printing apparatus 30. In the embodiment, the control apparatus 10, the image processing apparatus 20, and the printing apparatus 30 are connected directly or indirectly via a network. In FIG. 1, one control apparatus 10, four image processing apparatuses 20, and two printing apparatuses 30 are shown as an example, and the number of these apparatuses is not limited to the number shown in FIG. 1. The apparatuses are not limited in a connection mode, and may be connected via a local network or the Internet. The image processing apparatus 20 and the printing apparatus 30 may be connected to each other via local connection such as USB.

The image processing control system 1 is a system used when executing printing related to a print job using one or more printing apparatuses 30. When executing printing in the printing apparatus 30, image data, for example, portable document format (PDF) data, is specified as an object to be printed. When executing printing, image processing is performed based on the image data. For example, processing of converting an object into raster data based on a printing apparatus description language included in PDF data, scaling processing, color conversion processing, page layout determination processing on a print medium, and halftone processing are executed. In the embodiment, the processing of converting into raster data is performed when preview data for a print preview is generated and when print data for executing printing is generated.

In commercial printing, since a data amount of the data to be printed may be very large, image processing thereof may be high-load processing. Accordingly, for example, in a case of performing a plurality of print jobs in parallel by the printing apparatuses 30, the image processing may be a bottleneck of an entire printing operation. Therefore, in the embodiment, the plurality of image processing apparatuses 20 can perform distributed image processing. Hereinafter, a configuration of each apparatus provided in the image processing control system 1 will be described.

### (1-1) Configuration of Printing Apparatus

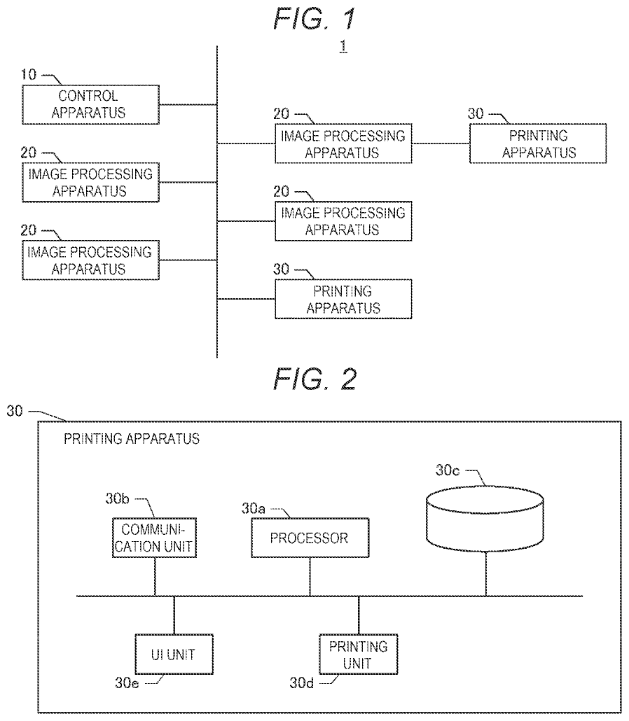

FIG. 2 is a block diagram illustrating a configuration of the printing apparatus 30. The printing apparatus 30 includes a processor 30a, a communication unit 30b, a nonvolatile memory 30c, a printing unit 30d, and a UI unit 30e. The processor 30a includes a CPU, a ROM, a RAM, and the like (not shown), and can execute various programs stored in the nonvolatile memory 30c and control each unit of the printing apparatus 30.

The processor 30a may be implemented by a single chip, may be implemented by a plurality of chips, or may be implemented as an SoC together with various functional blocks. For example, an ASIC may be adopted instead of the CPU, or the CPU and the ASIC may cooperate with each other. When each apparatus in the embodiment includes a processor, the processor can be implemented in various forms similarly to the processor 30a.

The communication unit 30b includes a communication interface for communicating with an external device according to various communication protocols. The printing apparatus 30 can communicate with the image processing apparatus 20 through the communication unit 30b. Naturally, the printing apparatus 30 may be able to communicate with the control apparatus 10. The communication unit 30b may include an interface for communicating with various removable memories mounted on the printing apparatus 30.

The printing unit 30d is a portion for executing printing, and prints contents on a print medium. A printing method is not limited, and various methods such as an ink jet method, a toner method, and a sublimation method can be adopted. The print medium is not limited to printing paper, and may be various print media such as cloth, pottery, and resin. The printing unit 30d includes an actuator, various devices, a sensor, a drive circuit, a mechanical component, and the like for executing printing on various print media.

The UI unit 30e includes at least any of a touch panel display, various keys, a switch, an LED, and the like. The touch panel display includes a display panel that displays various types of information, such as a status of the printing apparatus 30 and a remaining amount of ink, and a touch detection panel superimposed on the display panel, and detects a touch operation. The LED performs lighting or blinking display indicating a status or the like of the printing apparatus 30. The processor 30a can acquire operation contents of a user via the UI unit 30e. The processor 30a can also display various types of information on a display of the UI unit 30e and notify the user of the information.

In the embodiment, the printing apparatus 30 can perform printing based on print data transmitted from the image processing apparatus 20. That is, the processor 30a acquires the print data from the image processing apparatus 20 via the communication unit 30b and controls the printing unit 30d based on the print data to perform printing.

### (1-2) Configuration of Control Apparatus

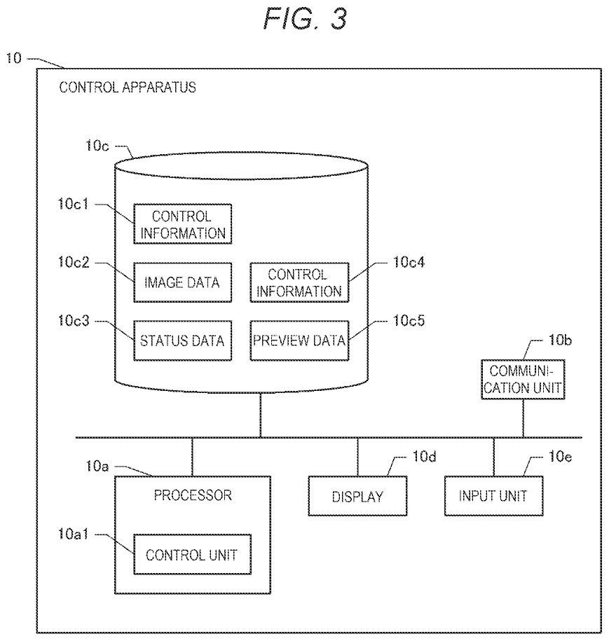

FIG. 3 is a block diagram illustrating a configuration of the control apparatus 10. The control apparatus 10 includes a processor 10a, a communication unit 10b, a nonvolatile memory 10c, a display 10d, and an input unit 10e. The processor 10a includes a CPU, a ROM, a RAM, and the like (not shown), and can execute various programs stored in the nonvolatile memory 10c and control each unit of the control apparatus 10.

The communication unit 10b includes a communication interface for communicating with an external device according to various communication protocols. The control apparatus 10 can communicate with the image processing apparatus 20 via the communication unit 10b. Naturally, the control apparatus 10 may be able to communicate with the printing apparatus 30. The communication unit 10b may include an interface for communicating with various removable memories mounted on the control apparatus 10.

The display 10d is a display device that displays any image. The input unit 10e is a device through which a user performs an input operation, and includes, for example, a keyboard and a mouse. In the embodiment, it is assumed that the control apparatus 10 is a stationary terminal, and naturally, the control apparatus 10 may be a terminal of another form. For example, the control apparatus 10 may be a tablet terminal or a smartphone terminal. In the case of such a terminal, the input unit 10e may be implemented by a touch panel or the like. In any case, the user can input his/her intention by operating the input unit 10e while visually recognizing an image or a character displayed on the display 10d. In the embodiment, the display 10d corresponds to a display unit that displays a print preview.

Control information 10l, image data 10c2, status data 10c3, control information 10c4, and preview data 10c5 are stored in the nonvolatile memory 10c of the control apparatus 10. The control information 10c4 is information for specifying the image data 10c2 to be printed, the image processing apparatus 20 to execute image processing for generating the preview data 10c5 of the image data 10c2, and an output destination of the generated preview data 10c5. The control information 10c1 is information for specifying the image data 10c2 to be printed, the image processing apparatus 20 to execute image processing after print instruction, and a printing apparatus to execute printing. The image data 10c2 is image data indicating print contents, and is, for example, a PDF file. In the embodiment, when the control information 10c4 or the control information 10c1 and the image data 10c2 are transferred as a set to the image processing apparatus 20, the image processing is performed. The image processing apparatus 20 to execute the image processing can be specified based on the control information 10c4 and the control information 10c1.

The status data 10c3 is information indicating progress of the image processing. In the embodiment, when each image processing unit provided in the image processing apparatus 20 starts processing and when the image processing unit ends the processing, the image processing apparatus 20 transmits information indicating the start and information indicating the end to the control apparatus 10. The transmitted information is stored in the nonvolatile memory 10c as the status data 10c3.

The processor 10a executes a control program (not shown). When the processor 10a executes the control program, the processor 10a functions as a control unit 10a1. The processor 10a functions as the control unit 10a1 that causes a plurality of image processing units of the image processing apparatus 20 described later to execute image processing. In the embodiment, the control unit 10a1 selects the image processing apparatus 20 to execute image processing for generating preview data for a print preview, generates the control information 10c4, and outputs the control information 10c4 together with the image data 10c2 to the image processing apparatus 20. The control information 10c4 includes a preview data generation request, an output destination of generated preview data, and a print setting. When the image processing apparatus 20 generates the preview data 10c5, the control information 10c4 and the preview data 10c5 are output to the output destination specified in the control information 10c4. The control unit 10a1 can acquire the generated preview data 10c5 by referring to the output destination specified in the control information 10c4.

In the embodiment, the control unit 10a1 monitors a monitored folder that is a predetermined storage location in the control apparatus 10, and the monitored folder is specified, in the control information 10c4, as the output destination of the preview data 10c5. The monitored folder is a folder associated with the control unit 10a1, and is secured in the nonvolatile memory 10c. The folder can be specified by a path. That is, it is possible to specify the folder by a path that starts with identification information (an IP address in the embodiment) of the control apparatus 10 and describes folder names in order from upper hierarchies to the folder.

When the preview data 10c5 and the control information 10c4 are newly stored in the monitored folder of the control unit 10a1, the control unit 10a1 can recognize that the preview data 10c5 whose creation is requested by the control information 10c4 is generated. Then, the control unit 10a1 can lay out the preview data 10c5, which is raster data, on a page based on a parameter indicating the print setting in the control information 10c4, and display the preview data 10c5 as a print preview on the display 10d.

When the user confirms the print preview displayed on the display 10d and determines that no correction is required, the user can input a print instruction by operating the input unit 10e. When the user confirms the print preview and determines that a correction is required, the user can correct the print setting by operating the input unit 10e. When the print setting is changed, the control unit 10a1 reflects the changed print setting in the control information 10c4, and transmits the control information 10c4 and the image data 10c2 to any of the image processing apparatuses 20 to request generation of the preview data 10c5 again. The image processing apparatus 20 serving as a generation request destination of the preview data after correction may be the same as or different from the image processing apparatus 20 serving as the generation request destination of the preview data before correction. When the image processing apparatus 20 generates the preview data 10c5 according to the corrected print setting and outputs the generated preview data 10c5 to the above-described storage location, the control unit 10a1 can recognize that the preview data 10c5 is regenerated. Similarly to the above, the control unit 10a1 can display a print preview based on the preview data 10c5. When the user confirms the print preview displayed on the display 10d and determines that no correction is required, the user can input a print instruction by operating the input unit 10e. As described above, the generation of the preview data is performed by an apparatus other than the control apparatus 10, and the generated preview data is acquired to perform a print preview based on the preview data. Accordingly, a load of the control apparatus 10 is reduced.

Upon receiving the print instruction from the user, the control unit 10a1 generates the control information 10c1 including information for specifying the image processing apparatus 20 to execute image processing for generating print data, and transfers the control information 10c1 to the image processing apparatus 20. In this way, the image processing apparatuses 20 are sequentially selected without being controlled by the control apparatus 10.

Therefore, the control unit 10a1 performs control to cause the plurality of image processing units provided in the image processing apparatus 20 to execute the image processing, and does not perform management of selecting the image processing apparatus 20 each time according to the progress of the image processing. That is, the control unit 10a1 generates the control information 10c1 and transfers the control information 10c1 and the image data 10c2, which is an object to be processed, to the image processing apparatus 20 including a first image processing unit that is an initial image processing unit. With this processing, it can be said that the control unit 10a1 performs control such that the image processing apparatuses 20 are sequentially selected. After the information is transferred to the first image processing unit, the printing apparatus 30 completes the printing even when the control unit 10a1 does not perform control processing such as selecting the image processing apparatus 20. Therefore, a processing load required for the control unit 10a1 to distribute the image processing is extremely small.

The control information 10c1 includes the information for specifying the image processing apparatus 20 that is to execute the image processing. Alternatively, the image processing apparatus 20 that is to execute the image processing may be determined automatically by the control unit 10a1 or determined by the user. In the case of automatic determination by the control unit 10a1, for example, a configuration may be adopted in which the number of reservations of processing is equally distributed to the image processing units provided in the plurality of image processing apparatuses 20. In the case of determination by the user, a configuration may be adopted in which the image processing units of each image processing apparatus 20 are displayed on the display 10d, and a specification of the user is received through the input unit 10e. In any case, for each print job, which image processing unit of which image processing apparatus 20 executes image processing necessary for printing is determined in advance, and described in the control information 10c1 by the control unit 10a1.

The control unit 10a1 in the embodiment can execute processing according to the status data. When the status data 10c3 is stored in the nonvolatile memory 10c, the control unit 10a1 can execute processing according to the status data 10c3. The processing according to the status data 10c3 may be various types of processing, such as displaying a status. Specifically, the control unit 10a1 refers to the status data 10c3 and displays, on the display 10d, a progress status of the image processing indicated by the status data 10c3. According to this configuration, the user can grasp the progress of the image processing related to the print job. The processing according to the status data 10c3 is not limited to display, and a warning according to the status may be issued, or progress management such as standby or restart of image processing may be performed according to the status.

### (1-3) Configuration of Image Processing Apparatus

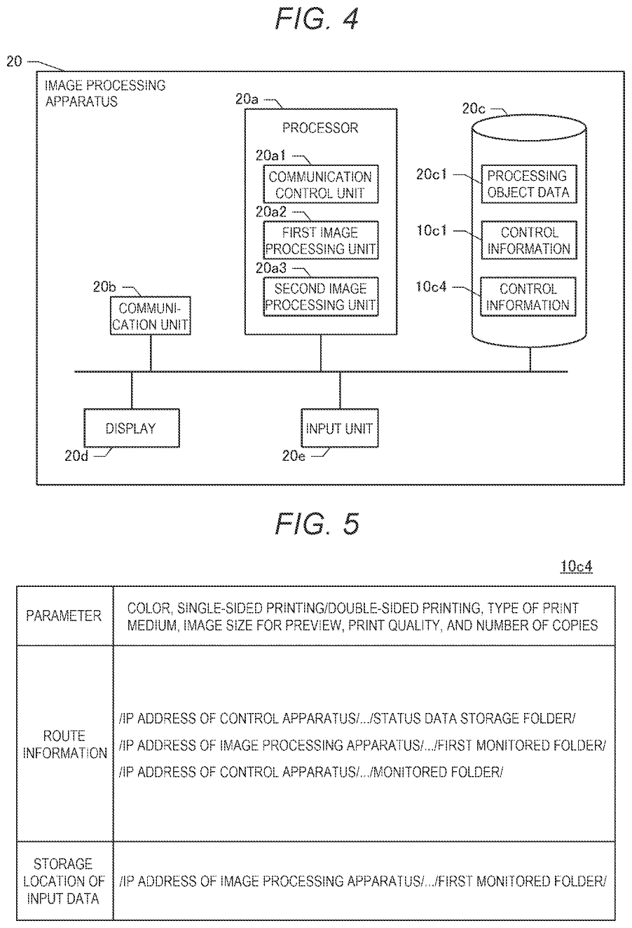

FIG. 4 is a block diagram illustrating a configuration of the image processing apparatus 20. The image processing apparatus 20 includes a processor 20a, a communication unit 20b, a nonvolatile memory 20c, a display 20d, and an input unit 20e. The processor 20a includes a CPU, ROM, RAM, and the like (not shown), and can execute various programs stored in the nonvolatile memory 20c and control each unit of the image processing apparatus 20. The processor 20a can also execute various types of arithmetic processing such as image processing.

The communication unit 20b includes a communication interface for communicating with an external device according to various communication protocols. The image processing apparatus 20 can communicate with the control apparatus 10 and the printing apparatus 30 via the communication unit 20b. The communication unit 20b may include an interface for communicating with various removable memories mounted on the image processing apparatus 20.

The display 20d is a display device that displays any image. The input unit 20e is a device through which a user performs an input operation, and includes, for example, a keyboard and a mouse. In the embodiment, it is assumed that the image processing apparatus 20 is a stationary terminal, and naturally, the image processing apparatus 20 may be a terminal of another form. For example, the control apparatus 10 may be a tablet terminal or a smartphone terminal. When the image processing apparatus 20 is such a terminal, the input unit 20e may be implemented by a touch panel or the like. In any case, the user can input his/her intention by operating the input unit 20e while visually recognizing an image or a character displayed on the display 20d. In the nonvolatile memory 20c, the control information 10c1 and 10c4 and processing object data 20c1, which is data in a process of processing performed by the image processing unit, are stored.

The processor 20a executes a print control program (not shown). When the processor 20a executes the print control program, the processor 20a functions as a communication control unit 20a1, a first image processing unit 20a2, and a second image processing unit 20a3. The processor 20a of the image processing apparatus 20 in FIG. 4 can implement the first image processing unit 20a2 and the second image processing unit 20a3. Alternatively, the processor 20a may be configured to implement at least one of these image processing units.

In the embodiment, each of communication control unit 20a1, first image processing unit 20a2, and second image processing unit 20a3 monitors a predetermined storage location. When the control information 10c1 or the control information 10c4 is newly stored at the storage location, the corresponding unit performs processing according to the stored control information. Specifically, the information stored in the nonvolatile memory 20c is stored in a folder that is a logical storage location having a hierarchical structure.

In the embodiment, a print monitored folder as a folder monitored by the communication control unit 20a1, a first monitored folder as a folder monitored by the first image processing unit 20a2, and a second monitored folder as a folder monitored by the second image processing unit 20a3 are set in advance. That is, each folder is associated with a corresponding processing unit. Each folder can be specified by a path. That is, it is possible to specify each folder by a path that starts with identification information (an IP address in the embodiment) of the image processing apparatus 20 and describes folder names in order from upper hierarchies to the target folder. The image processing control system 1 according to the embodiment may include a plurality of image processing apparatuses 20, and different image processing apparatuses 20 have different identification information included in the path. Accordingly, monitored objects of the first image processing units 20a2 and the second image processing units 20a3 provided in the different image processing apparatuses 20 are different folders, and the folders are distinguished by different paths.

The communication control unit 20a1 controls communication between the image processing apparatus 20 and the printing apparatus 30. In the embodiment, when the control information 10c1 is stored in the print monitored folder, the communication control unit 20a1 starts processing based on the control information 10c1. In the embodiment, since the print data is stored in the print monitored folder together with the control information 10c1, the communication control unit 20a1 transmits the print data to the printing apparatus 30 indicated by the control information 10c1 and causes the printing apparatus 30 to perform printing. In the embodiment, the print monitored folder is associated with the printing apparatus 30. Accordingly, when the print data is stored in the print monitored folder, the printing apparatus 30 associated with the print monitored folder is specified as a printing subject.

Each of the first image processing unit 20a2 and the second image processing unit 20a3 executes a part of image processing for performing printing in the printing apparatus 30. In the embodiment, the first image processing unit 20a2 executes an initial part of image processing among a series of processing of converting the image data 10c2 into the print data that can be processed by the printing apparatus 30. The second image processing unit 20a3 executes image processing to be executed after the image processing performed by the first image processing unit 20a2.

Output data processed by the second image processing unit 20a3 is the print data that can be processed by the printing apparatus. Accordingly, when the first image processing unit 20a2 processes the image data and the second image processing unit 20a3 processes the processed data, the print data that can be processed by the printing apparatus 30 is generated.

As long as the first image processing unit 20a2 and the second image processing unit 20a3 are image processing units that execute the series of image processing, each of the first image processing unit 20a2 and the second image processing unit 20a3 may handle any part of the series of image processing. In the embodiment, the first image processing unit 20a2 handles processing up to rasterization, for example, analysis based on the printing apparatus description language included in the image data 10c2 and conversion processing to raster data. In the case of preview data generation, conversion processing to raster data with a lower resolution than in the case of print data generation is performed. The second image processing unit 20a3 handles processing after the rasterization, for example, color conversion processing of the raster data based on an ICC profile, page layout determination processing on a print medium, and halftone processing.

The first image processing unit 20a2 and the second image processing unit 20a3 execute the image processing, and for each processing unit, entities of data input and data output are different. In the present specification, data to be processed by each processing unit may be referred to as input data and data generated by the processing may be referred to as output data. The input data and the output data are the processing object data 20c1 shown in FIG. 4.

In the embodiment, when the control information 10c4 is stored in the first monitored folder, the first image processing unit 20a2 starts processing based on the control information 10c4. In the embodiment, the image data 10c2 (processing object data 20c1) for which preview data is generated is stored in the first monitored folder together with the control information 10c4. The first image processing unit 20a2 generates the raster data by performing rasterization processing based on the image data, and generates the preview data 10c5 by laying out the raster data on a page. The first image processing unit 20a2 stores the generated preview data 10c5 in the monitored folder of the control unit 10a1 that is the output destination specified in the control information 10c4. As a result, as described above, the control unit 10a1 displays a print preview based on the preview data 10c5. When the user inputs a print instruction after the print preview is displayed, the control unit 10a1 stores the control information 10c1 and the image data in the first monitored folder.

When the control information 10c1 and the image data, which is input data to be processed, are stored in the first monitored folder, the first image processing unit 20a2 starts processing based on the control information 10c1. The first image processing unit 20a2 generates the raster data as output data based on the input data, and stores the output data in the second monitored folder indicated by the control information 10c1.

When the control information 10c1 and the raster data, which is input data to be processed, are stored in the second monitored folder, the second image processing unit 20a3 starts processing based on the control information 10c1. The second image processing unit 20a3 generates the print data that is output data based on the input data, and stores the output data in the print monitored folder indicated by the control information 10c1. The storage into the print monitored folder is a processing start request to the communication control unit 20a1.

Although FIG. 4 illustrates a configuration of one image processing apparatus 20, the image processing control system 1 includes a plurality of image processing apparatuses 20 as illustrated in FIG. 1. In the embodiment, the image data is converted into the print data by using any of a plurality of the first image processing units 20a2 and the second image processing units 20a3 that exist in a distributed manner in the plurality of image processing apparatuses 20. The first image processing unit 20a2 and the second image processing unit 20a3 that execute the image processing may be provided in different image processing apparatuses 20, and an image processing unit to perform the image processing is specified by the control information 10c1. Accordingly, when the control information 10c1 is generated in the control apparatus 10 and the control information 10c1 is stored in the first monitored folder to start the image processing performed by the first image processing unit 20a2, the control apparatus 10 does not need to perform processing related to distribution of the image processing units thereafter. Accordingly, in the control apparatus 10, it is not necessary to perform processing of determining a distribution destination of the image processing, processing of allocating data before and after the image processing, or the like, and thus the processing load is reduced as compared with a case where such processing is performed.

### (2) Control Information

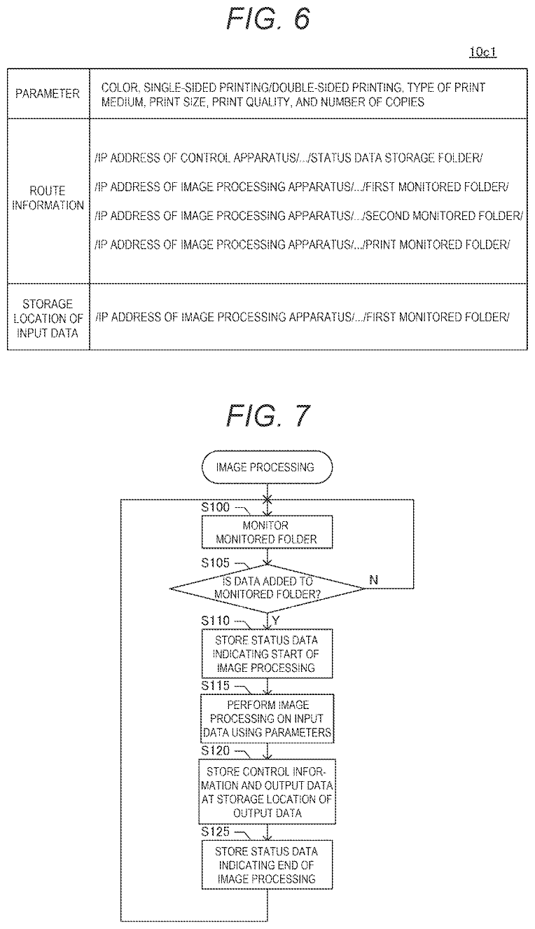

FIGS. 5 and 6 are tables illustrating an example of the control information 10c4 for preview data generation and an example of the control information 10c1 for print data generation and print execution. In the embodiment, the control information 10c4 and the control information 10c1 include a parameter used in the image processing, route information, and a storage location of input data. In the embodiment, the parameter used in the image processing is a print setting. FIGS. 5 and 6 show examples of print settings. In FIG. 5, a color, single-sided printing/double-sided printing, a type of print medium, a print size, a print quality, and the number of copies are shown as examples of print settings. Since contents of the image processing may vary due to the settings, parameters are included in the control information 10c1 and 10c4. For example, when a color setting is black and white, the raster data to be generated by the first image processing unit 20a2 is generated in grayscale. For example, the first image processing unit 20a2 specifies a resolution according to the print size and the print quality, and generates the raster data according to the resolution. In the control information 10c1, the resolution for generating the print data is shown by the print size and the print quality. In the case of the control information 10c4 for preview data generation, a parameter (for example, an image size of raster data for preview) indicating a request for generating the preview data is set. In the embodiment, the number of pixels of raster data for preview is smaller (a lower resolution) than the number of pixels of raster data for generating the print data. In the embodiment, a parameter indicating a resolution of the raster data for preview included in the control information 10c4 is regarded as a preview data generation request. In the embodiment, parameters other than the parameters related to the resolution of the raster data are common to the control information 10c1 and the control information 10c4. Since the control information includes the print setting, the image processing unit can refer to the print setting included in the control information to perform image processing using the print setting. That is, the control unit 10a1 does not need to instruct the print setting each time the image processing unit performs the image processing, and the processing load of the control unit 10a1 can be reduced.

The route information is information indicating a route along which the processing object data transitions in order to cause the image processing unit to execute processing. In the embodiment, the route information includes information specifying an image processing unit that is to perform a series of processing for printing among the plurality of image processing units. Specifically, the route information includes a path of a monitored folder monitored by the image processing unit that is to perform the processing. Since the monitored folder is associated with the image processing unit, specifying the monitored folder by the path is equivalent to specifying the image processing unit that is to perform the processing.

The storage location where the status data 10c3 is stored in the nonvolatile memory 10c of the control apparatus 10 in the embodiment is a specific folder determined in advance. Here, this folder is referred to as a status data storage folder. In the embodiment, each image processing unit generates the status data 10c3 indicating progress in a process of processing, and stores the status data 10c3 in the status data storage folder. As a result, the status data 10c3 indicating the progress of the series of processing for printing is sequentially stored in the status data storage folder in the nonvolatile memory 10c of the control apparatus 10. Therefore, it is possible to specify the progress of the image processing in the control apparatus 10.

The route information in the control information 10c4 includes a path of the status data storage folder and a path of the monitored folder monitored by the control unit 10a1. The route information in the control information 10c1 includes paths of the status data storage folder, the monitored folders monitored by the image processing units, and the monitored folder monitored by the communication control unit 20a1. A description mode of the paths may be various, and in the embodiment, the route information is formed such that the path of the status data storage folder is the first one and following paths are described in order of progress of the image processing.

For example, in the example illustrated in FIG. 5, the path of the status data storage folder is described first (at the top) in the route information. That is, the path of the status data storage folder, which starts with an IP address of the control apparatus 10 and ends with a name of the status data storage folder, is disposed first in the route information. Next to the path of the status data storage folder, a path of the first monitored folder monitored by the first image processing unit 20a2 that performs first image processing for generating preview data is described. That is, the path of the first monitored folder, which starts with an IP address of the image processing apparatus 20 and ends with a name of the first monitored folder, is disposed. Next to the path of the first monitored folder, the path of the monitored folder of the control unit 10a1 that is the output destination of the preview data is described. That is, the path of the monitored folder of the control unit 10a1, which starts with an IP address of the control apparatus 10 and ends with a name of the monitored folder, is described. The storage location of the input data indicates a path of a folder in which the input data to be processed by the first image processing unit 20a2 is stored. In the embodiment, the monitored folder associated with the image processing unit is the storage location of the input data. Accordingly, in the embodiment, the storage location of the control information 10c4 coincides with the storage location of the input data, and the input data and the control information 10c4 are stored as a set in the monitored folder.

In the example illustrated in FIG. 5, the storage location of the input data is indicated by the path of the first monitored folder. Accordingly, the control information 10c4 illustrated in FIG. 5 is information transferred to the first image processing unit 20a2, and when the control information 10c4 is transferred to the control unit 10a1, the storage location of the input data is rewritten. That is, when the output data is output to the control unit 10a1 after the first image processing unit 20a2 performs the image processing based on the control information 10c4 illustrated in FIG. 5, the storage location of the input data is rewritten to the path of the monitored folder of the control unit 10a1.

In the case of control information 10c1 shown in FIG. 6, the path of the monitored folder monitored by the first image processing unit 20a2 performing the first image processing is described next to the path of the status data storage folder. That is, the path of the first monitored folder, which starts with an IP address of the image processing apparatus 20 and ends with a name of the first monitored folder, is disposed. Next, the path of the second monitored folder is disposed, and finally, the path of the print monitored folder is disposed, whereby the route information is formed.

The storage location of the input data is specified by a path of a folder where the input data to be processed by the first image processing unit 20a2 or the second image processing unit 20a3 is stored. In the embodiment, the monitored folders associated with the respective image processing units are the storage locations of the input data. Accordingly, in the embodiment, the storage location of the control information 10c1 coincides with the storage location of the input data, and the input data and the control information 10c1 are stored as a set in the monitored folder. Accordingly, the control information 10c1 may be considered as including the input data. Other types of data necessary for the image processing, for example, an ICC profile may be stored at the storage location of the input data.

In the example illustrated in FIG. 6, the storage location of the input data is indicated by the path of the first monitored folder. Accordingly, the control information 10c1 illustrated in FIG. 6 is information transferred to the first image processing unit 20a2, and, when the control information 10c1 is transferred to the second image processing unit 20a3, the storage location of the input data is rewritten. That is, when the first image processing unit 20a2 performs the image processing based on the control information 10c1 illustrated in FIG. 6 and then outputs the output data to the second image processing unit 20a3 that performs the following processing, the storage location of the input data is rewritten to the path of the second monitored folder.

The image processing unit can acquire the input data to be processed, by referring to the storage location of the input data indicated by the control information 10c4 or the control information 10c1. In the examples illustrated in FIGS. 5 and 6, the storage locations of the input data coincides with the storage locations of the control information 10c4 and the control information 10c1, that is, the monitored folders.

In the route information, the paths of the folders monitored by the image processing units are described according to the order of image processing. Accordingly, an image processing unit that performs a certain part of image processing can specify that a monitored folder described next to the monitored folder associated with the image processing unit is a folder monitored by an image processing unit which is to perform the following image processing. For example, in the example illustrated in FIG. 6, when the first image processing unit 20a2 performs the image processing, it can be specified that the second image processing unit 20a3 associated with the second monitored folder described next to the first monitored folder monitored by the first image processing unit 20a2 is to perform the following processing.

### (3) Image Processing

Next, the image processing executed by the image processing unit based on the control information 10c4 and 10c1 will be described. The control information 10c4 and 10c1 are generated in the control apparatus 10. In the control apparatus 10, an application program (not shown) can be executed, and the user can use the display 10d and the input unit 10e as user interfaces and select any piece of image data to be printed. The user can input the print settings for the image data by operating the input unit 10e.

When the print settings are input, the control information 10c4 is generated by the function of the control unit 10a1. The control information 10c4 may be automatically generated by the control unit 10a1 or may be generated by the user. For example, in the case of automatic generation, the control unit 10a1 generates the control information 10c4 that specifies selection of any of the image processing apparatuses 20 including the first image processing unit 20a2, execution of the first image processing of the first image processing unit 20a2 of the selected image processing apparatus 20 to generate preview data, and output of the generated preview data to the monitored folder of the control unit 10a1. When the control information 10c4 is generated, the control unit 10a1 stores the control information 10c4 and the input data in the monitored folder of the first image processing unit 20a2 indicated in the control information 10c4.

When printing is instructed by the user, the control information 10c1 is generated by the function of the control unit 10a1. The control information 10c1 may be automatically generated by the control unit 10a1 or may be generated by the user. In the case of generation by the user, for example, the user operates the input unit 10e to specify the image processing apparatus 20 and the image processing unit that are to execute the image processing from options of the image processing units displayed on the display 10d, and the printing apparatus 30. Then, the control unit 10a1 generates the control information 10c1 for performing the image processing in the specified image processing unit and performing printing in the specified printing apparatus 30.

When the control information 10c1 is generated, the control unit 10a1 stores the control information 10c1 and the input data in the monitored folder of the first image processing unit 20a2 indicated in the control information 10c1. Thereafter, the image processing unit performs the image processing in an order indicated in the control information 10c1.

FIG. 7 is a flowchart of the image processing. The image processing is processing executed by each of the first image processing unit 20a2 and the second image processing unit 20a3. Although differences may occur in the parameter, the input data, and the output data in this processing, a flow of the processing is common to the image processing units, and thus the flow of the processing will be described herein without distinguishing the differences between the image processing units.

The first image processing unit 20a2 and the second image processing unit 20a3 installed in the image processing apparatus 20 each execute the image processing shown in FIG. 7. In the image processing, the image processing unit monitors a monitored folder (step S100) and determines whether data is added to the monitored folder (step S105). That is, the image processing unit periodically refers to the monitored folder associated in advance with the image processing unit and determines whether new data is added. When it is not determined that new data is added, the image processing unit executes step S100 and subsequent steps.

When it is determined in step S105 that new data is added to the monitored folder, the control information (10c4 or 10c1) and the input data are stored as a set in the monitored folder. Therefore, the image processing unit stores status data indicating a start of the image processing (step S110). That is, the image processing unit refers to the control information to specify a path of a status data storage folder, outputs the status data 10c3 indicating the start of the image processing to the control apparatus 10, and stores the status data 10c3 in the status data storage folder.

Next, the image processing unit performs the image processing on the input data using parameters (step S115). That is, the image processing unit refers to the control information (10c4 or 10c1) to acquire the input data stored at a storage location of the input data, and specifies the parameters of the image processing based on the control information 10c1. Then, the image processing unit performs the image processing, in which the parameters are applied, on the input data, and generates output data.

Next, the image processing unit stores the control information (10c4 or 10c1) and the output data at a storage location of the output data (step S120). That is, the image processing unit refers to the control information to specify a monitored folder monitored by the image processing unit of the following processing, and stores the control information and the output data in the monitored folder.

Next, the image processing unit stores the status data indicating an end of the image processing (step S125). That is, the image processing unit refers to the control information (10c4 or 10c1) to specify the path of the status data storage folder, outputs the status data 10c3 indicating the end of the image processing to the control apparatus 10, and stores the status data 10c3 in the status data storage folder. According to the above configuration, the image processing can be sequentially executed in the order indicated by the control information (10c4 or 10c1).

### (4) Communication Control Processing

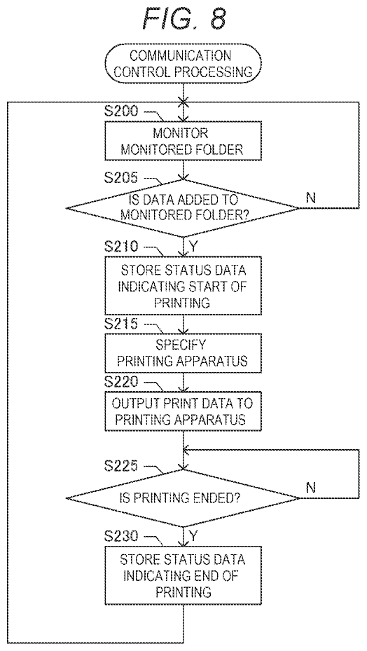

Next, communication control processing executed by the communication control unit 20a1 based on the control information 10c1 will be described. FIG. 8 is a flowchart of the communication control processing. The communication control processing is processing executed by the communication control unit 20a1. The communication control unit 20a1 installed in each image processing apparatus 20 executes the communication control processing illustrated in FIG. 8. In the communication control processing, the communication control unit 20a1 monitors a print monitored folder (step S200), and determines whether data is added to the print monitored folder (step S205). That is, the communication control unit 20a1 periodically refers to the print monitored folder associated in advance with the communication control unit 20a1 and determines whether new data is added. When it is not determined that new data is added to the print monitored folder, the communication control unit 20a1 executes step S200 and subsequent steps.

When it is determined in step S205 that new data is added to the print monitored folder, the control information 10c1 and the input data are stored as a set in the print monitored folder. Therefore, the communication control unit 20a1 stores status data indicating a start of printing (step S210). That is, the communication control unit 20a1 refers to the control information 10c1 to specify a path of a status data storage folder, outputs the status data 10c3 indicating the start of printing to the control apparatus 10, and stores the status data 10c3 in the status data storage folder.

Next, the communication control unit 20a1 specifies a printing apparatus (step S215). That is, the communication control unit 20a1 refers to the control information 10c1 to specify a print monitored folder, and specifies the printing apparatus corresponding to the print monitored folder. Next, the communication control unit 20a1 outputs print data to the printing apparatus 30 (step S220). That is, the output data stored in the print monitored folder is the print data to be output to the printing apparatus 30 specified in step S215. Therefore, the communication control unit 20a1 outputs the print data to the printing apparatus 30. As a result, the printing apparatus 30 as an output destination executes printing based on the print data.

When the printing is ended in the printing apparatus 30, the printing apparatus 30 notifies the communication control unit 20a1, which is an output source of the print data, of the end of printing. The communication control unit 20a1 determines whether the printing is ended based on the notification (step S225), and repeats the determination of step S225 until it is determined that the printing is ended.

When it is determined in step S225 that the printing is ended, the communication control unit 20a1 stores the status data indicating an end of printing (step S230). That is, the communication control unit 20a1 refers to the control information 10c1 to specify the path of the status data storage folder, outputs the status data 10c3 indicating the end of printing to the control apparatus 10, and stores the status data 10c3 in the status data storage folder. According to the above configuration, it is possible to execute printing based on the print data that is generated by performing the image processing according to the order indicated in the control information 10c1.

### (5) Examples

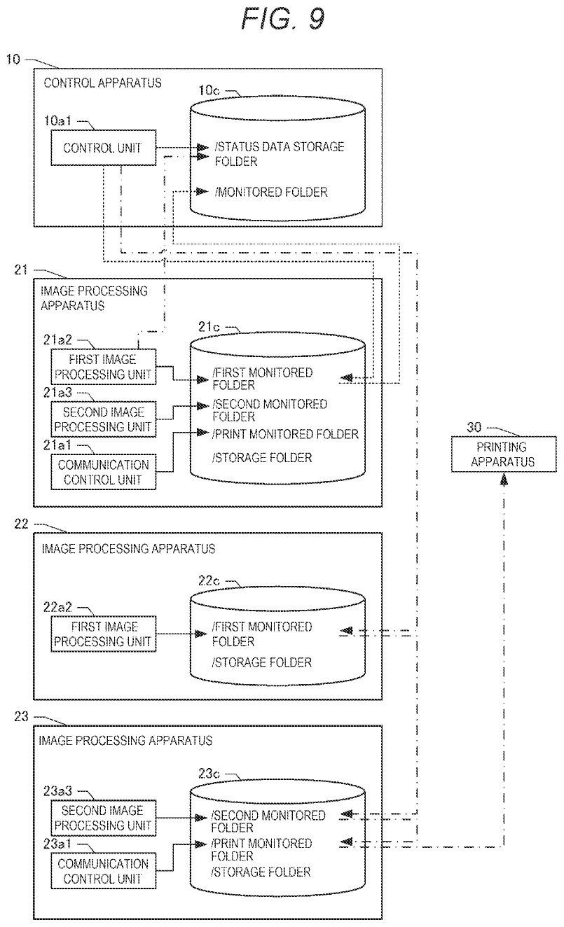

Next, a flow of the image processing according to the above-described configuration will be described as an example. FIG. 9 is a diagram illustrating a configuration example of the image processing control system 1. FIG. 9 illustrates an example in which one control apparatus 10, one printing apparatus 30, and three image processing apparatuses 20 are provided. To distinguish the three apparatuses from each other, the image processing apparatuses 20 are denoted as image processing apparatuses 21, 22, and 23. In FIG. 9, a part of the configurations of the control apparatus 10 and the image processing apparatuses 21,22, and 23 are extracted and illustrated.

In the example illustrated in FIG. 9, the image processing apparatus 21 includes a first image processing unit 21a2 and a second image processing unit 21a3. The image processing apparatus 22 includes a first image processing unit 22a2 and does not include any second image processing unit. The image processing apparatus 23 includes a second image processing unit 23a3 and does not include any first image processing unit. The image processing apparatuses 21 and 23 include a communication control unit 21a1 and a communication control unit 23a1, respectively. Since the image processing apparatus 22 does not include any second image processing unit that generates print data to be output to the printing apparatus 30, no communication control unit is shown therein. Naturally, the image processing apparatus 22 may include a communication control unit that controls communication between the control apparatus 10 and the image processing apparatus 22.

In the example illustrated in FIG. 9, the control apparatus 10 includes the nonvolatile memory 10c, the image processing apparatus 22 includes a nonvolatile memory 22c, and the image processing apparatus 23 includes a nonvolatile memory 23c. Data stored in each nonvolatile memory is stored in association with a folder prepared in advance. In FIG. 9, folders set in nonvolatile memories 10c, 21c, 22c, and 23c are shown, and folders as monitored objects of the respective units are indicated by arrows of solid lines extending from the control unit 10a1, the image processing units, and the communication control units to the folders. FIG. 9 illustrates an example in which output data subjected to image processing performed by the image processing apparatuses 21, 22, and 23 can be stored without being transferred to the following processing, and folders for storing the output data are illustrated as storage folders.

In the above configuration, the image processing for converting the image data into the print data is executed by any of the image processing units provided in the image processing apparatuses 21, 22, and 23. That is, the image data is processed by any of the first image processing units 21a2 and 22a2, and the output data of the processing is processed by any of the second image processing units 21a3 and 23a3. In this way, the image processing unit that performs the processing can be selected as desired from the plurality of image processing units, and thus a processing load of the image processing can be distributed.

The distribution of the processing can be implemented by description of the folder paths in the control information 10c4 and the control information 10c1. An arrow of a broken line indicates an example of a flow of data for generating preview data, and an arrow of a one-dot chain line indicates an example of a flow of data for generating and printing print data. For example, when the first image processing unit 21a in the image processing apparatus 21 performs the first image processing for generating preview data, the control information 10c4 describes a path of the first monitored folder set in the image processing apparatus 21 and a path of the monitored folder set in the control apparatus 10, as indicated by the arrows of a broken line. When the control information 10c4 is stored in the first monitored folder of the image processing apparatus 21 together with the image data, the first image processing unit 21a2 performs the image processing using the image data as input data, and stores the control information 10c4 and the preview data 10c5 in the monitored folder of the control apparatus 10, the preview data 10c5 being taken as output data. When the control information 10c4 and the preview data 10c5 are stored in the monitored folder of the control apparatus 10, the control unit 10a1 performs layout processing based on the stored preview data 10c5 and control information 10c4, and displays a print preview. An arrow of a two-dot chain line indicates a flow of the status data 10c3. FIG. 9 illustrates an example of the flow when the status data 10c3 is transmitted from the first image processing unit 21a2 to the status data storage folder of the control apparatus 10. Naturally, when other image processing units each perform the image processing as described later, the status data 10c3 indicating progress in the other image processing units is sequentially stored in the status data storage folder.

When a print instruction of the user is received after the print preview is displayed, for example, as indicated by the arrows of a one-dot chain line, the image processing is performed by the first image processing unit 22a2 in the image processing apparatus 22 and the second image processing unit 23a3 in the image processing apparatus 23, and printing is performed by the printing apparatus 30. In this case, the control information 10c1 describes a path of the first monitored folder set in the image processing apparatus 22, and a path of the second monitored folder and a path of the print monitored folder set in the image processing apparatus 23.

When the control information 10c1 is stored in the first monitored folder of the image processing apparatus 22 together with the image data, the first image processing unit 22a2 performs the image processing using the image data as the input data, and stores the control information 10c1 and output data in the second monitored folder of the image processing apparatus 23. When the control information 10c1 and the output data are stored in the second monitored folder of the image processing apparatus 23, the second image processing unit 23a3 performs the image processing using the stored data as input data, and stores the control information 10c1 and output data in the print monitored folder of the image processing apparatus 23. When the control information 10c1 and the output data are stored in the print monitored folder of the image processing apparatus 23, the communication control unit 23a1 outputs print data, which is the stored data, to the printing apparatus 30. As a result, printing is executed in the printing apparatus 30.

As described above, in the embodiment, preview data can be generated by causing an image processing apparatus, which is an apparatus different from the control apparatus 10 operated by a user, to perform high-load image processing, and a print preview can be displayed on the control apparatus 10 using the generated preview data. Therefore, it is possible to prevent a processing load from being applied to the control apparatus 10. Therefore, for example, even when the control apparatus 10 is a low-spec apparatus, it is possible to implement a function of displaying a print preview. Further, in the embodiment, since the preview data having a resolution for preview is generated, it is not necessary to perform processing such as resolution conversion on the control apparatus 10 side and it is possible to prevent a processing load from being applied to the control apparatus 10, as compared with a case where data that is rasterized at a resolution for printing (generally, a resolution higher than the resolution for preview) is acquired from the image processing unit.

Further, in the embodiment, after the print preview, the image processing units as distribution destinations for print data generation and print execution are described in advance in the control information 10c1. Therefore, it is not necessary for the control apparatus 10 to perform management such as determining the image processing apparatus 20, which serves as an execution subject, after the image processing is started, and the processing load is reduced as compared with a case where the control apparatus 10 performs the management. As described, by distributing processing of a large number of jobs to a plurality of image processing apparatuses and performing the processing in parallel while reducing the processing load of the control apparatus 10, a processing waiting time can be significantly reduced as compared with a case where one apparatus processes the large number of jobs. Further, in the embodiment, it is determined in advance that the processing to be performed by the second image processing unit is performed after the image processing performed by the first image processing unit. Therefore, the image processing for converting the image data into the print data is subdivided, and a degree of freedom in selecting the distribution destination is increased as compared with a case where the image processing is not subdivided. It is sufficient that the distribution destination of the image processing is selected one by one from the first image processing unit and the second image processing unit, and the distribution destination can be easily selected.

Further, in the embodiment, the image processing unit monitors a monitored folder, and processing is started in response to update of data in the monitored folder. Accordingly, simply by processing of storing data in a predetermined folder, the input data and the output data necessary for the series of image processing can be transferred. Therefore, distribution destinations of the series of image processing can be defined by simple processing of describing paths in the control information.

Further, in the embodiment, since the control information and the input data are stored as a set in a common folder, it is not necessary to extract data used in the image processing from a plurality of storage destinations, and thus processing performed by the image processing unit can be simplified. Further, in the embodiment, since the control information includes parameters used in the image processing, it is not necessary to extract the parameters used in the image processing from a storage location different from that of the control information, and thus the processing performed by the image processing unit can be simplified.

### (6) Other Embodiments

The above-described embodiment is an example for implementing the disclosure, and various other embodiments may be adopted. For example, an apparatus configuration of the image processing control system is not limited to the configuration illustrated in FIG. 1. The control apparatus 10 and the image processing apparatus 20 may have a common configuration. Specifically, the control unit 10a1, the first image processing unit 20a2, and the second image processing unit 20a3 may be installed in computers, and each computer may function as any of the control apparatus 10 and the image processing apparatus 20. In this case, each computer includes the first image processing unit 20a2 and the second image processing unit 20a3, and a specific computer may be set to function as one of the first image processing unit 20a2 and the second image processing unit 20a3 and not to function as the other.

The apparatuses shown in FIG. 1 may be a smaller number of terminals sharing functions or may be a larger number of terminals. For example, the image processing apparatus 20 and the printing apparatus 30 may be an integrated apparatus, and the control apparatus 10 and the image processing apparatus 20 may be implemented by a cloud computer.

It is sufficient that the image processing control system is a system including a plurality of image processing units that execute image processing for performing printing in a printing apparatus, and a control unit that causes the plurality of image processing units to execute the image processing. Accordingly, another configuration, for example, a printing apparatus may be provided. The number of image processing units is not limited, and a plurality of control units and printing apparatuses may be provided.

The control unit may request in parallel the plurality of image processing units to perform image processing for generating the preview data. For example, in a case where a plurality of files are combined into one print job, and image data of a first file is allocated to a first page and image data of a second file is allocated to a second page, the control information may be described such that the first image processing unit of the first image processing apparatus is requested to perform image processing for generating preview data of the first page and the first image processing unit of the second image processing apparatus is requested to perform image processing for generating preview data of the second page. In this case, it is possible to shorten the time required for generating preview data for all pages as compared with a case where image processing for generating preview data for all pages is performed by one image processing apparatus.

As long as the control unit can output a preview data generation request for the image data to be processed to the image processing unit selected from the plurality of image processing units, various modes can be adopted. For example, the preview data generation request may be output to the image processing apparatus in a form different from information indicating an output destination of the generated preview data, parameters of print settings, and information on a storage location of the image data or the like. When the preview data generation request is included in the control information and output to the image processing unit, rasterization processing for generating the preview data (that is, the preview data generation request) may be explicitly distinguished, by a factor other than resolution, from a processing request of rasterization processing for generating the print data. In this case, the image processing unit may perform the rasterization processing for generating the preview data when the control information includes the explicit information indicating the rasterization processing for generating the preview data, and perform the rasterization processing for generating the print data when the control information does not include the explicit information. The explicit information may be, for example, that a preview flag is set to ON, or that characters “preview” are included.

The control unit may request in parallel different image processing units to perform the image processing for generating the preview data and the image processing for generating the print data. That is, the control unit generates the control information 10c1 and the control information 10c4, outputs the control information 10c4 and the image data 10c2 to the first image processing unit of the first image processing apparatus to request generation of the preview data 10c5, and outputs the control information 10c1 and the image data 10c2 to the first image processing unit of the second image processing apparatus to start the first image processing for generating the print data at least before receiving a print instruction from a user. In this case, the printing apparatus stands by until a print instruction is received from a user. Specifically, for example, output data subjected to second image processing is described in the control information 10c1 so as to be output to a storage folder instead of the print monitored folder, and when a print instruction is received from the user, for example, the control unit reads the output data (that is, print data) from the storage folder and moves the output data to a print monitored folder monitored by a communication control unit, and outputs the print data in the print monitored folder to the printing apparatus to execute printing. A specific method is not limited to the above example as long as the printing based on the print data generated in parallel with the generation of the preview data can be performed by releasing suspending of the printing based on the print data after the printing is suspended. As described above, in the case where the generation of the preview data and the generation of the print data are performed in parallel in different image processing units, it is possible to shorten the time from when the user confirms the print preview and gives the print instruction to when the printing is started, as compared with the case where the generation of the preview data and the generation of the print data are not performed in parallel as in the above-described embodiment. A display unit on which the print preview based on the preview data is displayed may be a display unit other than a display unit provided in the control apparatus.

In the above-described embodiment, the control information for preview data generation and the control information for print data generation and print execution are separately generated. Alternatively, one piece of control information, which describes a series of data flow from the preview data generation to the print data generation and printing execution and the parameters of print settings, may be generated when the control unit requests the image processing unit to generate the preview data.

The image processing units are distinguished from each other in a rasterization processing unit and a halftone processing unit, and are not limited thereto. For example, the image processing units may be distinguished from each other in layout processing and halftone processing. The image processing unit may execute processing up to the layout processing of laying out the preview data to a page, and the control unit may acquire the preview data in the laid out state and display a print preview.

The present disclosure is also applicable to a program and a method executed by a computer. The system, the program, and the method as described above may be implemented as a single apparatus or may be implemented by using components provided in a plurality of apparatuses, and include various forms. Further, the present disclosure may be modified appropriately, and for example, a part is designed to be software and a part is designed to be hardware. Furthermore, the present disclosure is also established as a storage medium of a program that controls the system. Naturally, the storage medium of the program may be a magnetic storage medium or a semiconductor memory, and any storage medium to be developed in the future can be considered in exactly the same way.

What is claimed is:

1. An image processing control system including a plurality of image processing units configured to execute image processing for performing printing in a printing apparatus and a control unit configured to cause the plurality of image processing units to execute the image processing, wherein
the control unit outputs a preview data generation request of image data to be processed to the image processing unit selected from the plurality of image processing units,
the selected image processing unit executes the image processing for generating preview data on the image data to generate the preview data, and outputs the generated preview data to the control unit, and
the control unit causes a display unit to display a print preview based on the preview data.

2. The image processing control system according to claim 1, wherein
the control unit outputs control information including the preview data generation request and an output destination of the generated preview data, and
the image processing unit outputs the generated preview data to the output destination of the preview data indicated in the control information.

3. The image processing control system according to claim 2, wherein
the control information includes, as an output destination of the preview data, information indicating a storage location associated with the control unit,
the image processing unit outputs the preview data to the storage location associated with the control unit that is indicated in the control information, and
the control unit displays the print preview based on the preview data stored at the storage location associated with the control unit.

4. The image processing control system according to claim 3, wherein
when a print instruction is received from a user after the print preview is displayed, the control unit outputs, to a first image processing unit, the control information including information indicating input data to be processed, the image processing unit that performs following processing on processed output data, and the printing apparatus that performs printing,
the first image processing unit performs first image processing on the input data based on the control information and outputs the output data to the image processing unit that performs following processing,
a last image processing unit performs last image processing based on the control information and outputs the output data to a storage location corresponding to the printing apparatus, and
the printing apparatus performs printing based on the output data stored at the storage location corresponding to the printing apparatus.

5. The image processing control system according to claim 4, wherein
the control information includes a print setting, and
the image processing unit performs the image processing for generating print data based on the print setting.

6. The image processing control system according to claim 5, wherein
when the print setting is changed after the print preview is displayed,
the control unit outputs the control information including the changed print setting, the preview data generation request, and an output destination of the generated preview data to the selected image processing unit,
the image processing unit generates the preview data based on the changed print setting and the image data, and outputs the generated preview data to the output destination of the preview data, and
the control unit displays the print preview based on the output preview data.

7. The image processing control system according to claim 6, wherein
the control unit requests different image processing units in parallel to perform the image processing for generating the preview data and the image processing for generating the print data.

8. A control apparatus comprising:
a control unit configured to output a preview data generation request of image data to be processed to an image processing apparatus, the image processing apparatus including an image processing unit selected from a plurality of image processing units, and cause a display unit to display a print preview based on preview data generated by the image processing unit executing image processing on the image data.

9. An image processing apparatus comprising:
an image processing unit configured to perform image processing on image data transmitted from a control apparatus to generate preview data and output the preview data to the control apparatus.
